(19) United States
(12) Patent Application Publication
(10) Pub. No.: US 2012/0033686 A1
(43) Pub. Date: Feb. 9, 2012

(54) ALL-GAIN GUIDING YB-DOBED FEMTOSECOND FIBER LASER

(75) Inventors: Mohamed A. Abdelalim, Ottawa (CA); Hanan Anis, Kanata (CA); Diaa Abdel-Maguid Mohamed Khalil, Cairo (EG)

(73) Assignee: The University of Ottawa, Ottawa, ON (CA)

(21) Appl. No.: 13/016,439

(22) Filed: Jan. 28, 2011

Related U.S. Application Data
(60) Provisional application No. 61/299,574, filed on Jan. 29, 2010.

(51) Int. Cl. H01S 3/30; B23P 11/00; H01S 3/098

(52) U.S. Cl. 372/6; 29/428

(57) ABSTRACT

A mode-locked fiber laser system is presented with an improved optical cavity structure having a lower doped and longer gain medium. The laser system comprises: a laser source operable to produce a light beam; an optical cavity structure operable to amplify a light beam propagating therethrough; and a beam splitter operable to output the amplified light beam from the optical cavity. The optical cavity includes a single-mode fiber section and a gain fiber section doped with a lanthanide element, such as erbium or ytterbium, where the ratio between length of the gain fiber section to a total length of the cavity structure is greater than 1:5. By increasing length of the gain medium, peak power of the generated pulse is increased while keeping the nonlinear phase shift constant to avoid optical wave breaking.

### CROSS-REFERENCE TO RELATED APPLICATIONS

This application claims the benefit of U.S. Provisional Application No. 61/299,574, filed on Jan. 29, 2010. The entire disclosure of the above application is incorporated herein by reference.

### FIELD

The present disclosure relates to femtosecond fiber lasers and, more particularly, to an improved optical cavity structure utilizing a lower doped and longer gain medium.

### BACKGROUND

Fiber lasers have attracted the attention of the researchers in the last two decades because of the advantages they offer over bulk solid state lasers, including greater stability, reduced alignment sensitivity, compact design, and unneeded cooling. Furthermore, fiber lasers do not need experts for operation while an expert is required for long time operation of the bulk solid state lasers. All these benefits and others make the fiber laser a promising source that can be efficiently used outside the laboratory environment in the near future. However, the lower amount of energy and power of the generated pulse from the fiber laser compared with those of the pulse generated from the bulk solid state laser limits the use of the fiber lasers in many applications. The main reason that limits the fiber laser pulse energy and power is the excessive nonlinear phase shift accumulated during the propagation through the fiber which causes wave breaking that manifests itself in the form of multiple pulsing. Many attempts to optimize the laser cavity dispersion map and design have been carried out to generate more intense and shorter pulses by avoiding pulse breaking.

Broadening of the pulse width using net positive group velocity dispersion (GVD) is a powerful way to increase the pulse energy. Drawing on this concept, higher pulse energies have been recently reported directly from large net normal GVD oscillators without external amplification; such as the so-called chirped pulse oscillator (CPO), and self-similar laser. A CPO produces highly chirped pulses which preserve their form during circulation in the cavity due to the weak dispersion map (DM) while the self-similar laser generates highly chirped pulses with a notable breathing ratio due to strong DM in the cavity. This self-similar evolution suppresses the wave breaking by developing a monotonic frequency chirp during pulse propagation; however, the pulse energy is limited by overdriving the nonlinear polarization evolution (NPE). By reducing the strength of the NPE and using an intra-cavity filter providing additional self-amplitude modulation, stable pulses with notably high energy up to 16.5 nJ are generated. Such all-normal dispersion (ANDi) fiber lasers contain an explicit spectral filter exhibiting a variety of pulse shapes and evolutions. The generated pulses from this ANDi fiber laser are found to balance not only phase modulation but also gain and loss, and thus they constitute dissipative solitons.

Therefore, it is desirable to develop a femtosecond fiber laser having increased pulse energy while maintaining a stable pulse. This section provides background information related to the present disclosure which is not necessarily prior art.

### SUMMARY

A mode-locked fiber laser system is presented with an improved optical cavity structure having a lower doped and longer gain medium. The laser system comprises: a laser source operable to produce a light beam; an optical cavity structure operable to amplify a light beam propagating therethrough; and a beam splitter operable to output the amplified light beam from the optical cavity. The optical cavity includes a single-mode fiber section and a gain fiber section doped with a lanthanide element, such as erbium or ytterbium, where the ratio between length of the gain fiber section to a total length of the cavity is greater than 1:5. By increasing length of the gain medium, peak power of the generated pulse is increased while keeping the nonlinear phase shift constant to avoid optical wave breaking.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 is a diagram depicting an exemplary mode-locked fiber laser system having an improved optical cavity structure;

FIGS. 2A-2C are graphs illustrating temporal profile of a generated pulse, including pulse intensity, pulse spectrum and pulse chirp, respectively;

FIGS. 3A-3F are graphs illustrating the effect of GVD on the pulse characteristics: temporal pulse intensity, spectrum pulse intensity, pulse width, spectrum width, pulse chirp and pulse energy, respectively, with a Yb-doped fiber having a nonlinear coefficient, γ, =0.005 W−1 m−1, bandwidth at 50 nmm, gain coefficient of 65 dB/m and a length of 0.6 m;

FIGS. 4A-4F are graphs illustrating the effect of nonlinearity on the pulse characteristics: temporal pulse intensity, spectrum pulse intensity, pulse width, spectrum width, pulse chirp and pulse energy, respectively, with a Yb-doped fiber having a group velocity dispersion at 24000 fs²/m, bandwidth at 50 nmm, gain coefficient of 65 dB/m and a length of 0.6 m;

FIGS. 5A-5F are graphs illustrating the effect of gain changes on pulse characteristics: temporal pulse intensity, spectrum pulse intensity, pulse width, spectrum width, pulse chirp and pulse energy, respectively, with a Yb-doped fiber having γ=0.005 W−1 m−1, group velocity dispersion at 24000 fs²/m, gain coefficient of 65 dB/m and a length of 0.6 m;

FIGS. 6A-6F are graphs illustrating the effect of fiber length on pulse characteristics: temporal pulse intensity, spectrum pulse intensity, pulse width, spectrum width, pulse chirp and pulse energy, respectively, with a Yb-doped fiber at γ=0.005 W−1 m−1, group velocity dispersion at 24000 fs²/m, bandwidth at 50 nmm and a gain coefficient of 65 dB/m;

FIGS. 7A-7F are graphs illustrating the effect of gain coefficient on the pulse characteristics: temporal pulse intensity, spectrum pulse intensity, pulse width, spectrum width, pulse chirp and pulse energy, respectively, with a Yb-doped fiber at γ=0.005 W−1 m−1, group velocity dispersion at 24000 fs²/m, bandwidth at 50 nmm and a length of 0.6 m;

FIG. 8 is a graph illustrating how the output peak power can be increased by increasing the length of the gain medium while keeping the nonlinear phase shift constant;

FIG. 9 is a graph illustrating fiber bandwidth and length domain division according to a generated pulse state at g₀=65 dB/m;

FIGS. 10A-10F are graphs illustrating pulse characteristics on the edge of the stability region;

FIG. 11 is a graph depicting displacement of the stability border as the fiber gain changes;

FIG. 12 is a graph depicting displacement of the stability border as the group velocity dispersion changes;

FIG. 13 is a graph depicting how fiber nonlinearity changes the stability border; and

FIGS. 14A and 14B are graphs illustrating the instability dynamics of the initially formed dissipative soliton.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

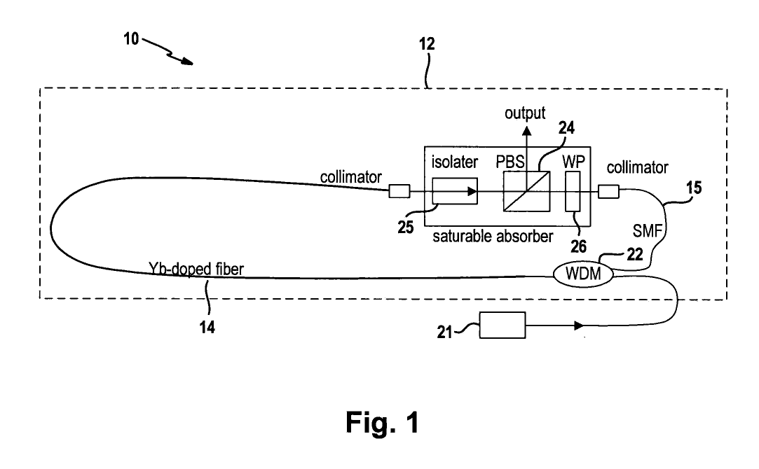

FIG. 1 depicts an exemplary mode-locked fiber laser system 10 having an improved optical cavity structure 12. The optical cavity structure 12 is primarily constructed from a low doped fiber 14 serving as the gain medium or gain fiber section of the structure. In an exemplary embodiment, the fiber is doped with a lanthanide element, such as erbium (Er) or ytterbium (Yb), although other types of elements are contemplated by this disclosure. The doped fiber is considerably longer than conventional gain mediums as described below. In addition, the doped fiber is doped at a concentration substantially lower (e.g., on the order of 30×10²⁴ ions/m³) than conventional gain mediums. It is understood that the most relevant optical components are presented but that other optical components may be needed to implement a suitable laser system.

In an exemplary embodiment, the optical cavity structure 12 further includes a WDM coupler 22 to support external pumping and a polarization beam splitter 24 for outputting light. The WDM coupler 22 is configured to receive a light beam from an external laser source 21 (e.g., operating at 980 nm); whereas, the polarization beam splitter 24 operates to output the light beam from the cavity as well as provides mode-locking action through nonlinear polarization evolution. A single mode fiber or some other type of fiber 15 may be optically coupled between the beam splitter 24 and the WDM coupler 22 but is not essential for obtaining results described below. The WDM coupler 22 interfaces with the optical cavity via single mode fiber terminals of negligible length. An isolator 25 may be employed to provide unidirectional propagation of the light beam through the cavity and a wave plate 26 may be used to control light polarization. It is envisioned that beam splitter may be replaced with other types of output couplers and that other mode locking mechanisms may be employed by the laser system such as a semi-conductor saturable absorber (SESAM). Furthermore, it is envisioned that other embodiments of the laser system may replace the free space optics of the optical cavity structure with an all fiber implementation.

Light propagation in a doped fiber is described by the Ginsburg-Landau equation. More specifically, light propagation for the complex amplitude in a Yb-doped fiber in the context of the laser system 10 is set forth as:

$$\frac{\partial A}{\partial z} = - \frac{α}{2} A - j \frac{{β}_{2}}{2} \frac{{\partial }^{2} A}{\partial {t}^{2}} + j γ {\vert A \vert}^{2} A + ( \frac{{g}_{0}}{1 + E / {E}_{sat .}} ) ( 1 + \frac{1}{{Ω}_{g}^{2}} \frac{{\partial }^{2}}{\partial {t}^{2}} ) A , \qquad ( 2.1 )$$

where z is the propagation coordinate, t is the retarding time, A(z,t) is the complex field amplitude, α is the linear loss taken as 0.04 m⁻¹, β₂ is the GVD parameter taken as 24000 fs²/m, γ is the nonlinear parameter taken as 0.005 W⁻¹m⁻¹, g₀ is the small signal gain parameter (e.g., 65 dB/m) with the parabolic frequency dependence and a bandwidth Ω_{g}=40 nm, E is the pulse energy, and Eₛₐₜ is the gain saturation energy (3 nJ).

Light propagation through a polarizer has been modeled as intensity dependent transmission

T=1−1₀/[1+Pₚᵤₗₛₑ/Pₛₐₜ] (2.2)

where l₀=0.5 is the unsaturated loss, P_{Pulse} is the pulse power and Pₛₐₜ=12 kW is the saturation power. Transmission characteristic corresponding to NPE can be described by sinusoidal function. However, for laser intensities below the over-driving point the transmission characteristic is quite a good fit for NPE as it has been shown in many theoretical and experimental studies. The total loss of the cavity has been taken as 10 dB corresponding to losses in all the different interfaces as well as to the light output from the cavity. The numerical method used is based on the split-step Fourier transform algorithm. As an initial condition, white noise has been used. A few thousand roundtrips are used to ensure that a stable mode-locked pulse operation has been reached.

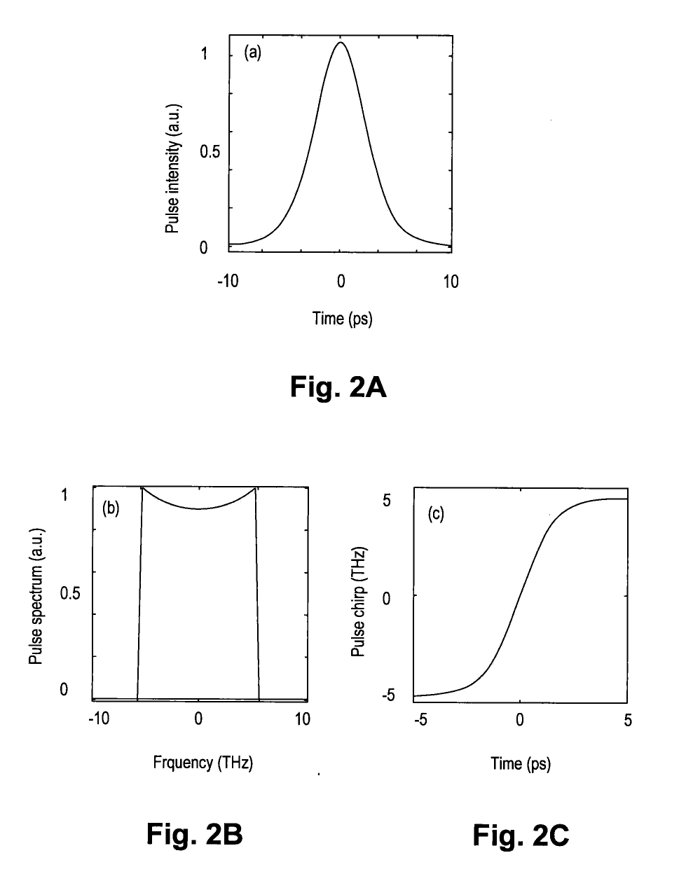

Stable pulses with linear chirp are generated numerically as depicted in FIGS. 2A-2C. The temporal profile of the generated pulse is plotted in FIG. 2A. A hyperbolic-secant shape function is fitting the temporal profile in FIG. 2A. The temporal profile is strictly fitted by sech-function so the generated pulse is considered to be a dissipative soliton. The corresponding spectrum of the generated pulse is illustrated in FIG. 2B is an M-shaped spectrum and the linear chirp of the pulse is shown in FIG. 2C. This linear chirp makes it able to compress the pulse outside the laser cavity without deformation using an anomalous dispersion element until a chirp free pulse is reached. Here the pulse chirp refers to time dependence of the instantaneous frequency of the pulse.

The region of stable mode-locked operation depends of various fiber parameters. Parameters of the doped fiber, such dispersion, nonlinearity, gain bandwidth, length, and gain, are studied for their effect on the pulse characteristics. Pulse characteristics considered include the temporal pulse profile and width, the spectrum pulse profile and width, the pulse chirp and the pulse energy.

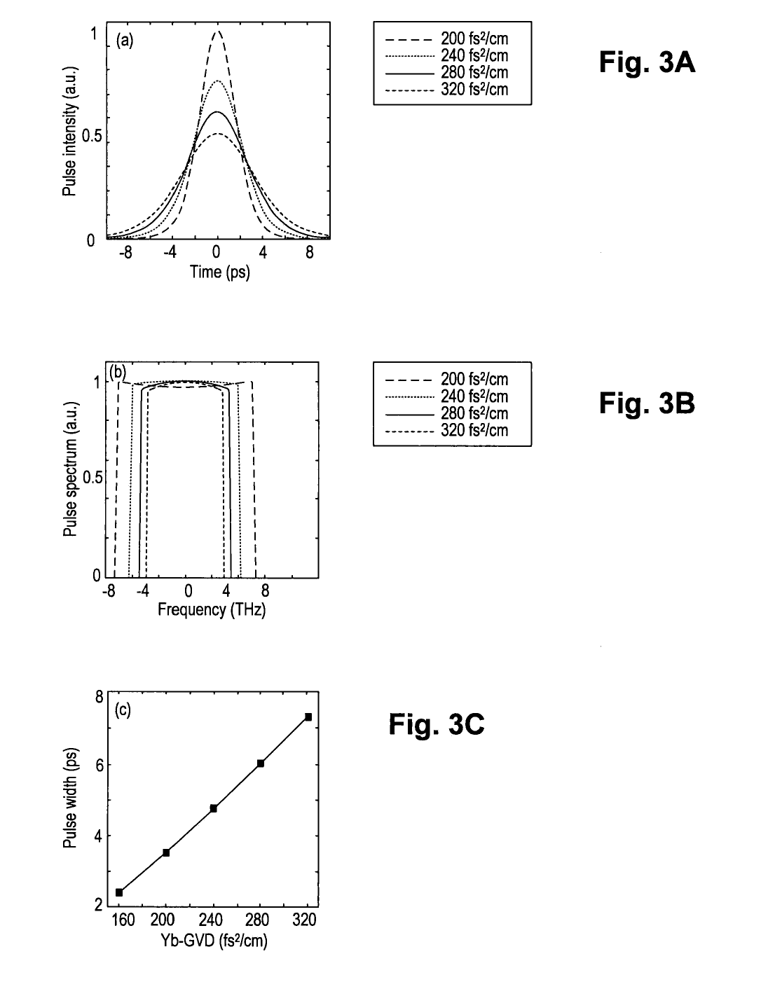

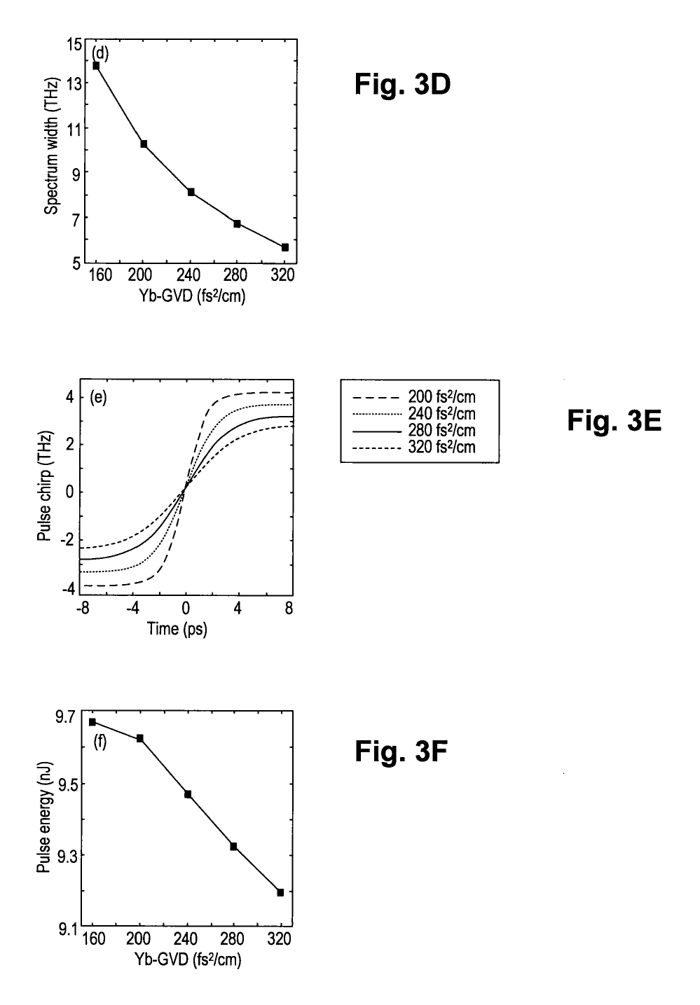

First, the effect of group velocity dispersion (GVD) on the pulse characteristics is investigated. With reference to FIGS. 3A-3F, the temporal pulse profile keeps its shape as a hyperbolic-secant function. As shown in FIG. 3A, the pulse becomes lower in amplitude and wider in width with increasing GVD as the GVD increases which is expected as a dispersion effect. However, the pulse spectrum changes from an M-like shape to a Π-like shape and then to parabolic-like shape as the GVD increases as shown in FIG. 3B. Referring to FIGS. 3C and 3D, the temporal pulse width increases while the spectrum width decreases with increasing GVD. This is also confirmed by the decrease in pulse chirp shown in FIG. 3E. On the other hand, the variation of the pulse energy with increasing GVD is quite weak as shown in FIG. 3F.

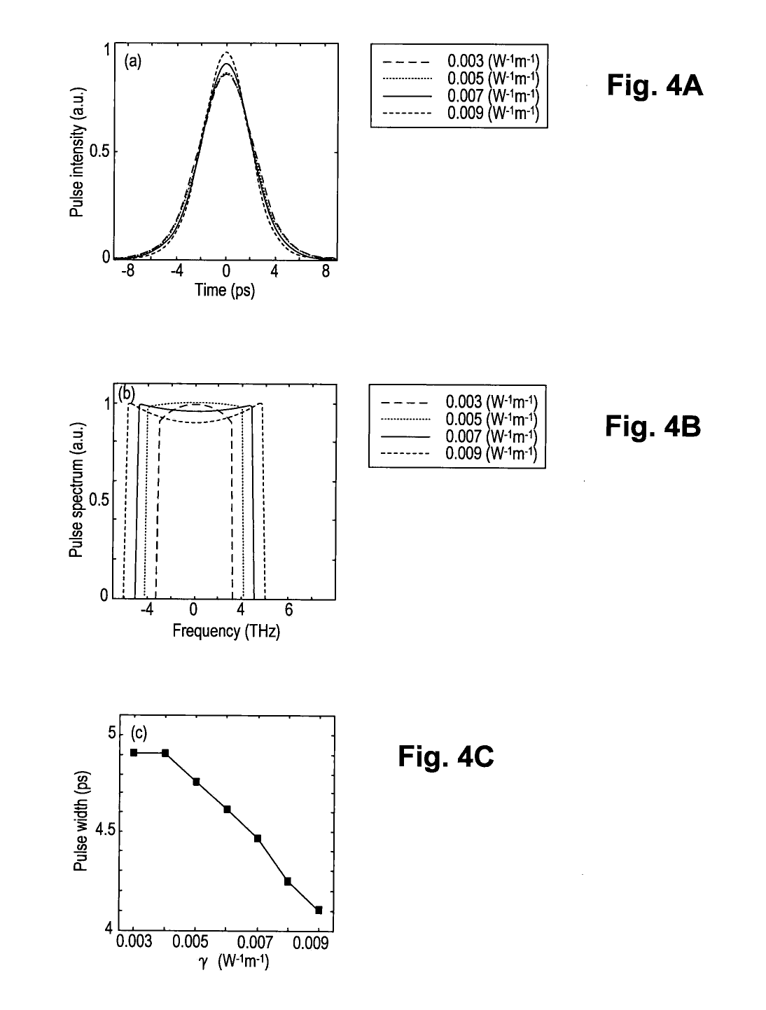

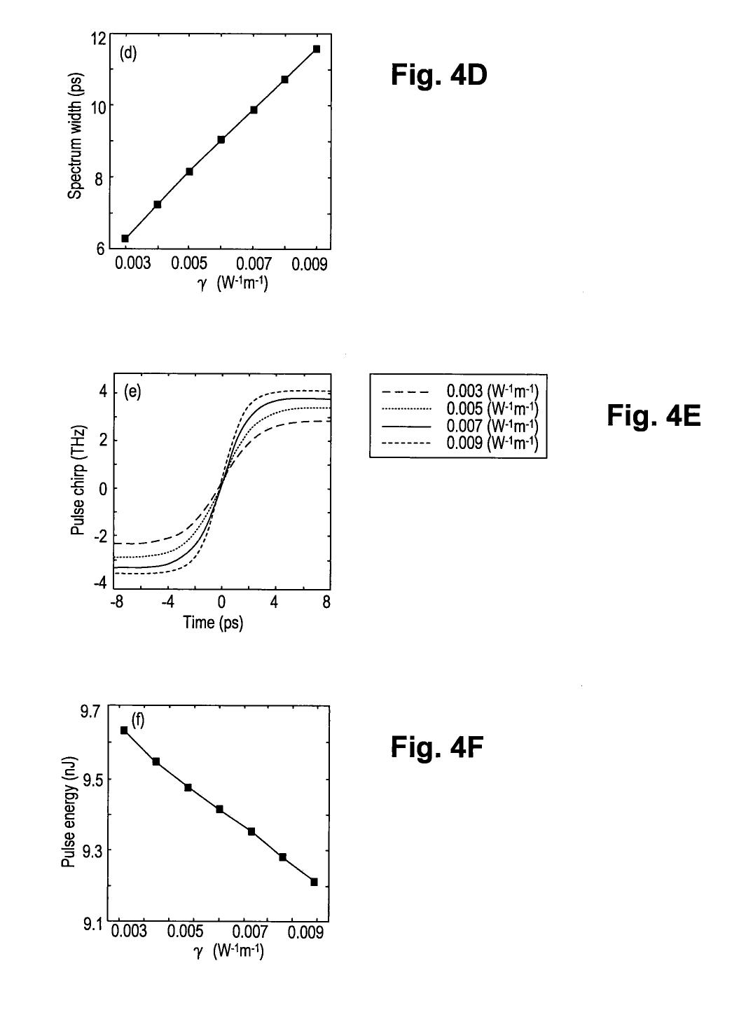

In general, the pulse characteristics are affected by increasing nonlinearity in a way similar to the situation when GVD decreases. Increasing nonlinearity keeps the temporal pulse profile as a hyperbolic-secant function with higher peaks as shown in FIG. 4A. In addition, it converts the spectrum profile from a parabolic-like shape to a Π-like shape and then to an M-like as shown in FIG. 4B. The temporal pulse width slightly decreases with increasing nonlinearity in FIG. 4C, while the spectrum width increases significantly in FIG. 4D. Obviously, the pulse chirp becomes stronger as the nonlinearity increases as shown in FIG. 4E. Again, insignificant changes in pulse energy are seen with nonlinearity change (see FIG. 4F), similar to the case of varying GVD (see FIG. 3F).

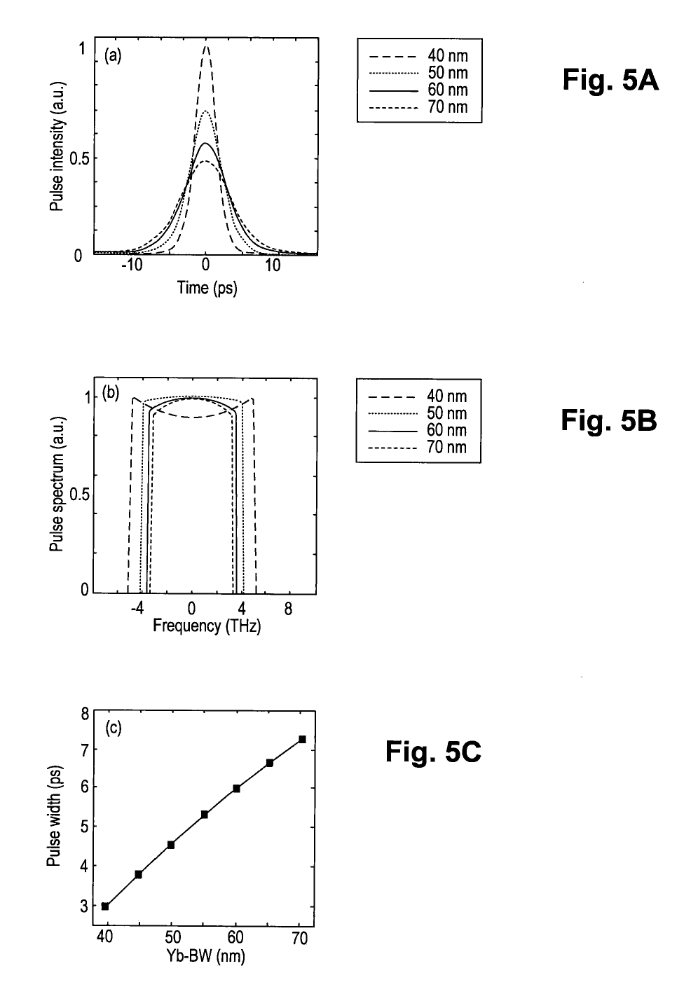

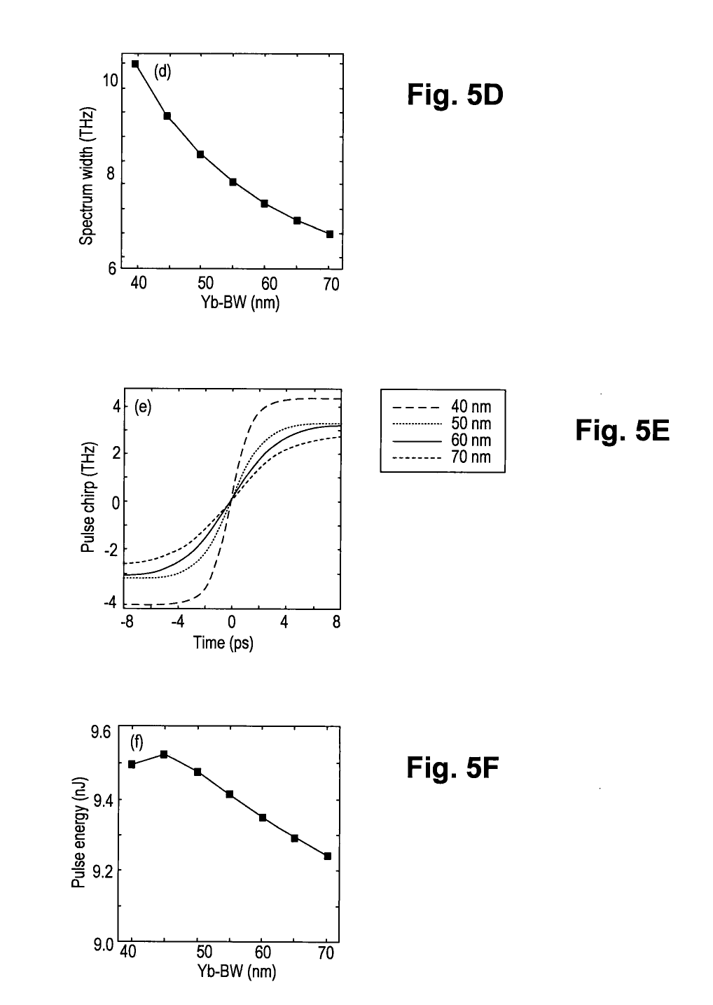

Remarkable behavior was observed in simulations when the gain bandwidth changes. Referring to FIG. 5A, the temporal pulse profile remains of a hyperbolic-secant shape function, with pulse peak getting higher and the pulse width narrower. With decreasing gain bandwidth, the pulse spectrum becomes wider and the spectrum profile takes on an M-like shape as shown in FIG. 5B. Changes in the pulse width, FIG. 5C, and of the spectral width, FIG. 5D with decreasing gain bandwidth are related to the chirp of the generated pulse, FIG. 5E, whose slope as well as maximum value increases with the decrease in bandwidth. The impact of the bandwidth on the pulse energy can be seen in FIG. 5F. It is apparent that, there is a weak inverse proportionally between the bandwidth and the energy of the generated pulse.

In the simulation, the laser configuration behaves as a function of the changing Yb-doped fiber gain bandwidth similar to that of the ANDi fiber laser when the spectral filter bandwidth changes. The same shortening of the mode-locked pulse and modification of the pulse spectrum from narrow parabolic to a wide M-like shape. A weak bandwidth dependence on the pulse energy is also observed. Therefore, inverse dependence between the Yb-fiber bandwidth and the mode-locked pulse width can be explained by the same mechanism as described by Buckley et. al in “Femtosecond fiber lasers with pulse energies above 10 nJ”, Opt. Letter 30, 1888-1890 (2005): narrow bandwidth leads to pulse shortening due to cutting off the high- and low-frequency wings of the pulse. The only difference between the data presented here and the results of the cited article is that we do not see high spikes along the spectrum edges which could be attributed to the stronger contribution of the GVD in the pulse shaping in our case.

It follows that spectral filtering can be achieved by adjusting the gain bandwidth of the gain fiber, thereby eliminating the need for any additional optical components that perform spectral filtering or dispersion compensation when constructing the optical cavity.

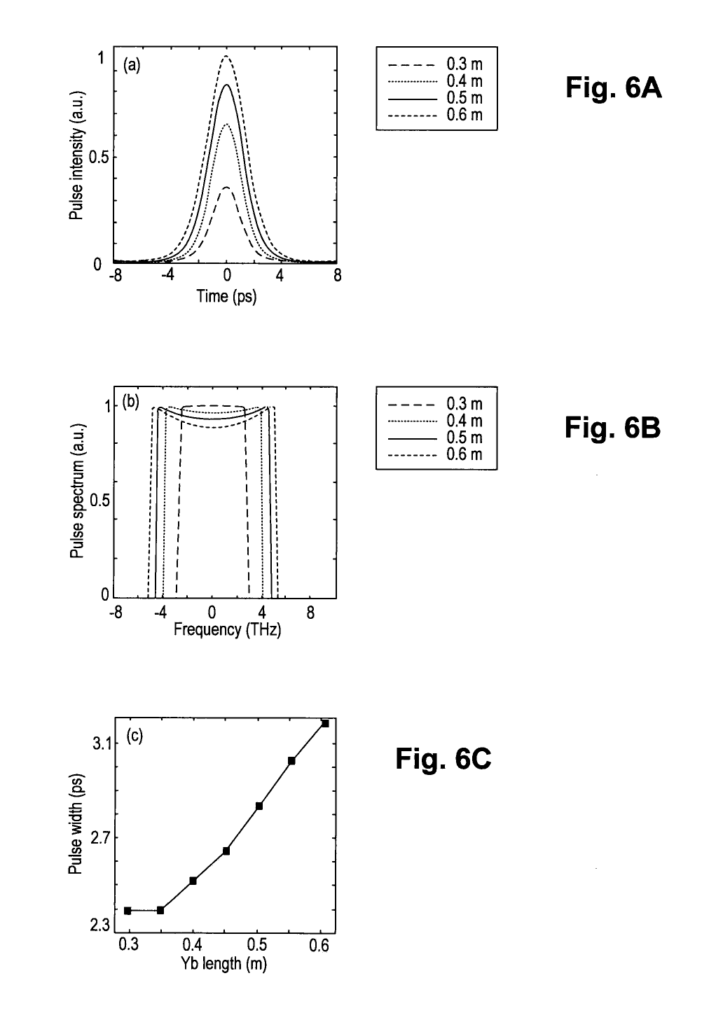

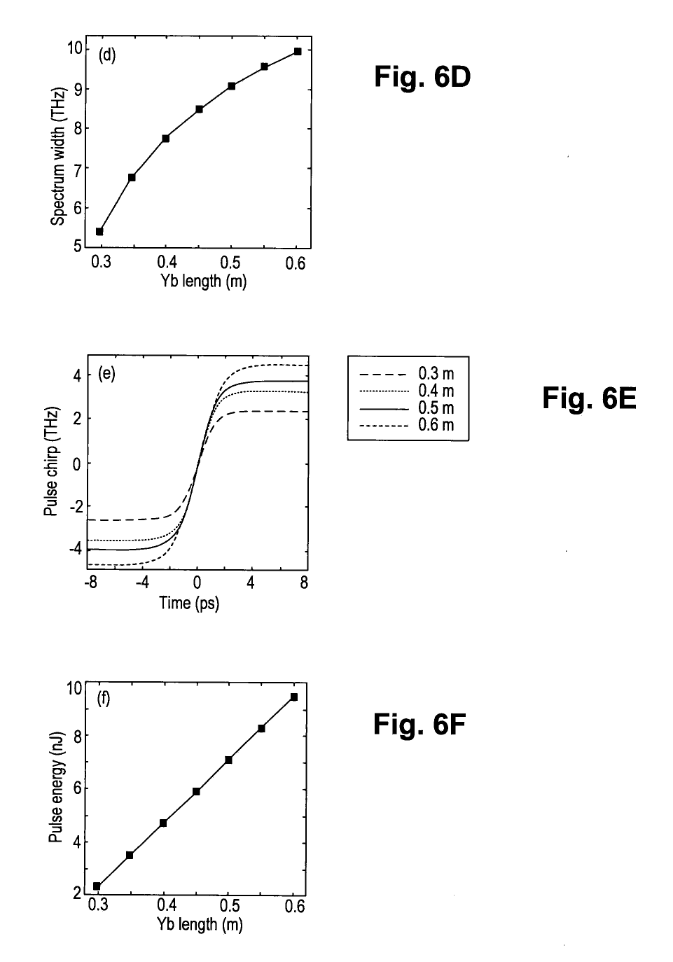

Change in the length of the Yb-doped fiber causes variation simultaneously in the cavity GVD, nonlinearity, and total gain. Naturally, the length of the Yb-doped fiber impacts not only the pulse characteristics but also on the pulse stability as will be explained below. It can be seen from FIG. 6A that the pulse intensity profile remains a hyperbolic-secant function with different peaks and pulse widths for different fiber lengths. Increasing pulse peaks and lengthening the fiber increases the pulse chirp and widens the pulse spectrum. As depicted in FIG. 4B, the effect of the length variation on the pulse spectrum profile is very weak and the spectrum remains as an M-like shape for different lengths of the Yb fiber except at short lengths the spectrum profile becomes Π-like shaped. Both the pulse and spectrum widths increase with increasing the fiber length as shown in FIGS. 4C and 4D. However, the impact on the pulse width is weaker than that on the spectral width. The increase of both cavity GVD and nonlinearity with increasing Yb-fiber length is the cause for both pulse and spectrum widening. As expected from the widening of the pulse spectrum, the maximum value of the linear chirp increases with increasing fiber length as shown in FIG. 6E. Increasing fiber length produces more amplification; therefore, it is noted that pulse energy significantly increases with the length as shown in FIG. 6F.

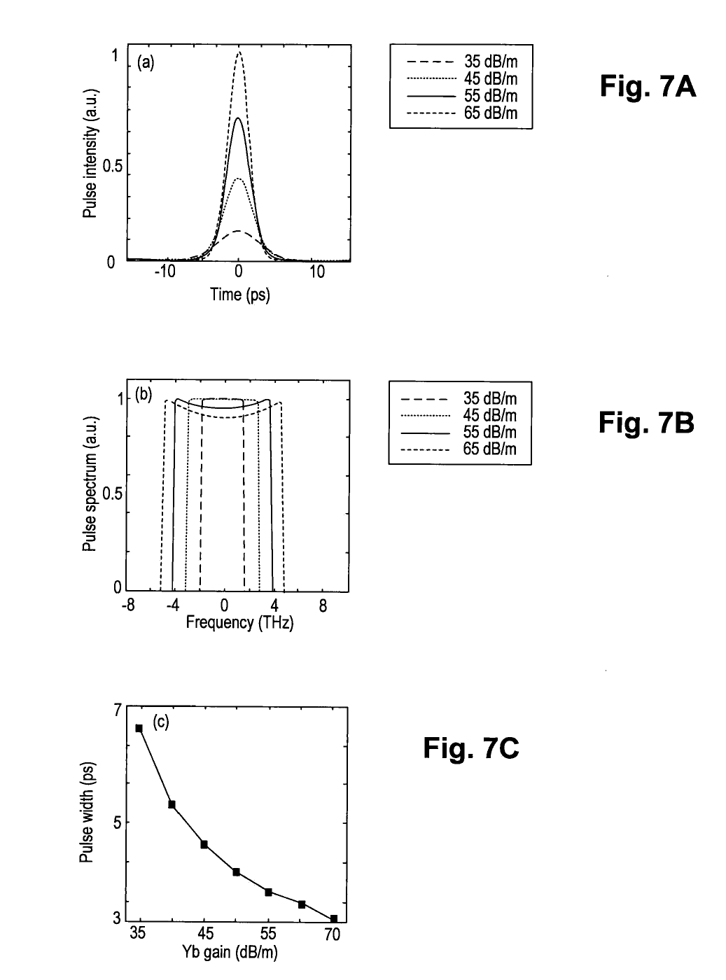

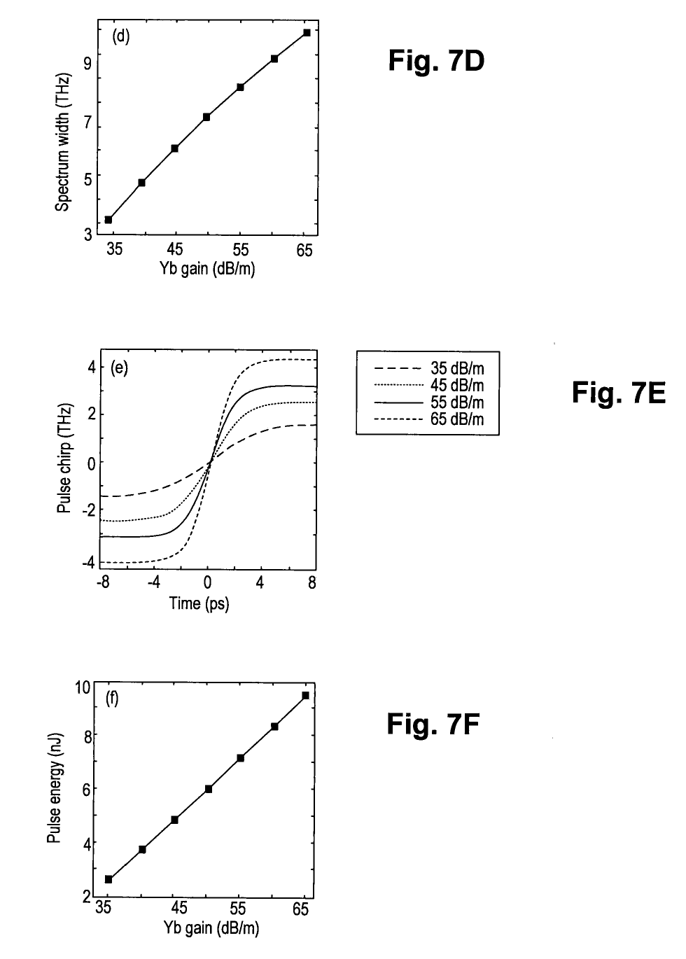

Variation of the Yb-fiber gain coefficient can be carried out experimentally by varying the input pumping power of the Yb-fiber. As the numerical results show, increasing the Yb-fiber gain keeps the temporal pulse profile as hyperbolic-secant shape with higher peak value (FIG. 5A), while it changes the spectrum profile of the generated pulse to an M-like shape (FIG. 5B). The impact of the Yb-fiber gain on the temporal width of the pulse is different from that of the Yb-fiber length. As the Yb-fiber gain increases the nonlinearity increases and therefore the temporal pulse width becomes narrower as shown in FIG. 7C. However, the increase of the Yb-fiber gain makes the spectrum wider as shown in FIG. 7D. This spectrum widening with increasing the Yb-fiber gain is related to the increase of the generated pulse chirp as shown in FIG. 7E. Also, the pulse energy grows naturally with Yb-fiber gain as depicted in FIG. 7F. Increasing the gain results in shorter pulse with wider spectrum and higher energy.

The behavior of the temporal and spectral profile depends on whether GVD or nonlinearity dominates in the optical cavity. The dominance of nonlinearity extensively increases the pulse's chirp and hence widens the spectrum converting it to the M-like shape. In contrast, dominance of the GVD widens the temporal pulse and suppresses the spectral spikes of the pulse transforming the spectrum profile to the parabolic-like. It should be noted that similar transition in the mode-locked pulse spectrum (from M-like shape to Π-like shape and then to parabolic-like shape) has been previously reported in a solid-state laser source with increasing net cavity GVD. However, in fiber lasers a transition of the pulse spectrum from an M-like shape to a parabolic-like shape directly without observing a Π-like shape has been demonstrated. Thus, the optimized Yb-dobed fiber laser demonstrates ability to generate a rich variety of spectral profiles including a Π-like shaped spectrum.

The effect of the bandwidth on the pulse characteristics is related to its amplitude modulation role, as the spectral clipping of the chirped pulse inside the cavity is mapped to time. Thus, decreasing the bandwidth has an effect on the pulse characteristics (see FIGS. 5A-5F), which is similar to that obtained by increasing the nonlinearity (see FIGS. 4A-4F). Gain and Yb-fiber length affect the pulse energy significantly while other parameters have approximately no effect on the pulse energy. Lengthening the Yb-fiber has a compound effect on the pulse characteristics because it increases both the GVD and the gain effects so each parameter has its own partial effect. Strictly speaking, lengthening the Yb-fiber noticeably increases the temporal pulse width as a result of the GVD and significantly widens the spectrum converting it to M-like shape. It is found that pulse energy is strongly affected by the Yb-fiber gain and length and it does not depend much on the GVD, nonlinearity and Yb-fiber gain bandwidth.

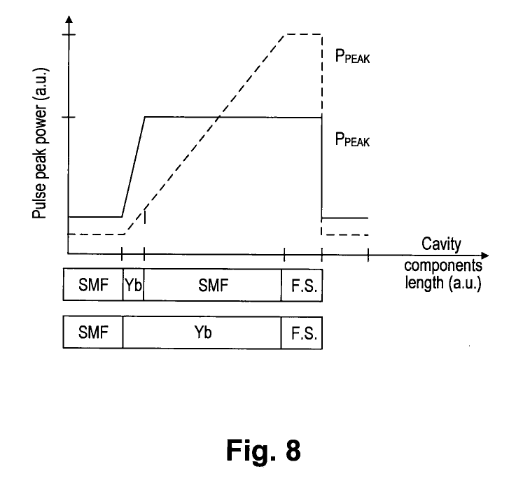

With reference to FIG. 8, a qualitative description of how the power of the output pulse can be grown up while keeping the nonlinear phase shift constant to avoid the optical wave breaking is presented. The maximum excessive nonlinear phase shift Φ_{Max} that limits the peak power of the generated pulse is approximated as

Φ_{Max}=ΣγPₚₑₐₖL (2.3)

where γ is nonlinear coefficient, Pₚₑₐₖ is the peak power, and L is the length of each section of the cavity. The summation is carried out on all sections constructing the laser cavity. Φ_{Max} is the area under Pₚₑₐₖ−L curve depicted by the solid line in FIG. 8. In a conventional high doped arrangement, the Yb-doped gain medium has a length on the order of 20-50 cm with the remainder of the single mode fiber having a length more than 2 meters. As discussed above, the output peak power can be increased by increasing the length of the gain medium as qualitatively shown by the dotted line in FIG. 8.

Further simulations were conducted to illustrate the effect of a lower doped, longer gain medium on the peak power. Simulation is repeated many times for longer Yb-doped fiber with lower gain values to have the total gain of the Yb constant. Moreover, to keep the repetition rate of the cavity constant the length of single mode fiber after the Yb-doped fiber is cut to compensate the extra length of the Yb-fiber. The simulated cavity parameters as well as the peak powers obtained are tabulated in the table below.

| L_{Yb} | L_{SMF2} | gₒ | P₁ | P₂ | P₃ | P₄ |
|---|---|---|---|---|---|---|
| (m) | (m) | (db/m) | (W) | (W) | (W) | (W) |
| 0.6 | 1 | 35 | 73.6084 | 587.2844 | 572.8051 | 79.3115 |
| 0.8 | 0.8 | 26.25 | 74.0999 | 587.8925 | 576.3321 | 79.7998 |
| 1 | 0.6 | 21 | 74.6881 | 589.2615 | 580.5963 | 80.3903 |
| 1.2 | 0.4 | 17.5 | 75.3759 | 591.3962 | 585.615 | 81.0852 |
| 1.4 | 0.2 | 15 | 76.1735 | 594.3603 | 591.4631 | 81.8949 |
| 1.6 | 0 | 13.125 | 77.0963 | 598.2547 | | 82.8353 |

L_{Yb} is the Yb-fiber length, L_{SMF2} is the length of the single mode fiber after the gain medium, P₁ is the peak power of the pulse entering the gain medium, P₂ is the peak power of the pulse exiting the gain medium, P₃ is the peak power of the pulse exiting the SMF after the gain medium, P₄ is the peak power of the pulse entering the SMF after the beam splitter. The ratio between length of the gain fiber section to length of the single-mode fiber section is preferably greater than 1:3. In some instances, the length of the gain fiber section exceeds the length of the single-mode fiber section. In other instances, the single-mode fiber section is eliminated from the optical cavity. In each of these instances, the gain fiber section is doped at a concentration that is substantially less than the conventional high doped gain medium (e.g. 200×10²⁴ ions/m³). For purposes of the simulation, the gain fiber section is doped at a concentration on the order of 30×10²⁴ ions/m³ but other concentration levels are also contemplated by this disclosure. Furthermore, the cavity structure is constructed such that the ratio between the length of the gain fiber section to the total length of the cavity structure is preferably greater than 1:5.

Not only does the lower doping Yb-fiber with longer length enhance the peak value of the pulse at the same total gain as demonstrated above, but also it increases the peak power of the pulse that can be supported by the cavity. The table below sets forth the maximum small signal gain gₒ, that can be used without optical wave breaking at different lengths of low-doped Yb-fiber as well as the associated peak power. The maximum gₒₘ and the maximum peak power after the gain medium at different low-doped Yb-fiber length P₂ are also tabulated in table.

| L_{Yb} | gₒ | gₒₘ | P₂ |
|---|---|---|---|
| (m) | (db/m) | (db/m) | (W) |
| 0.6 | 35 | 35 | 587.2844 |
| 0.8 | 26.25 | 27 | 610.0762 |
| 1 | 21 | 22.2 | 633.4535 |
| 1.2 | 17.5 | 19 | 657.4696 |
| 1.4 | 15 | 17.5714 | 725.0919 |
| 1.6 | 13.125 | 15.375 | 750.4931 |

Comparing the maximum power of 587.2844 W from the reference case to the maximum peak power of 750.4931 W achieved by varying the small signal gain yields a significant increase in peak power.

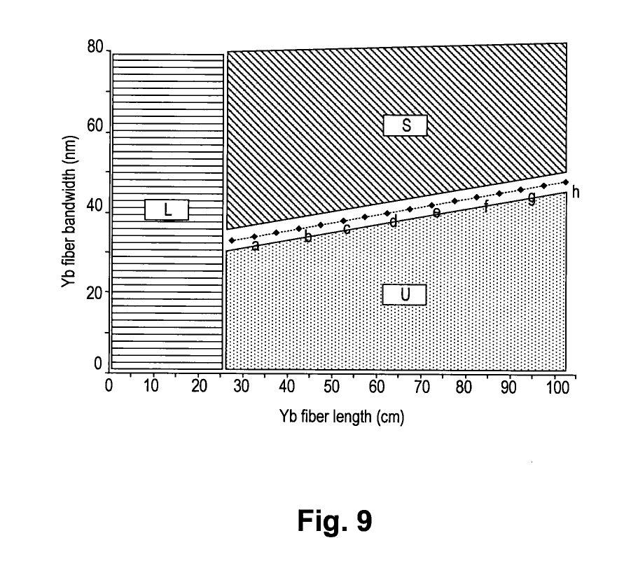

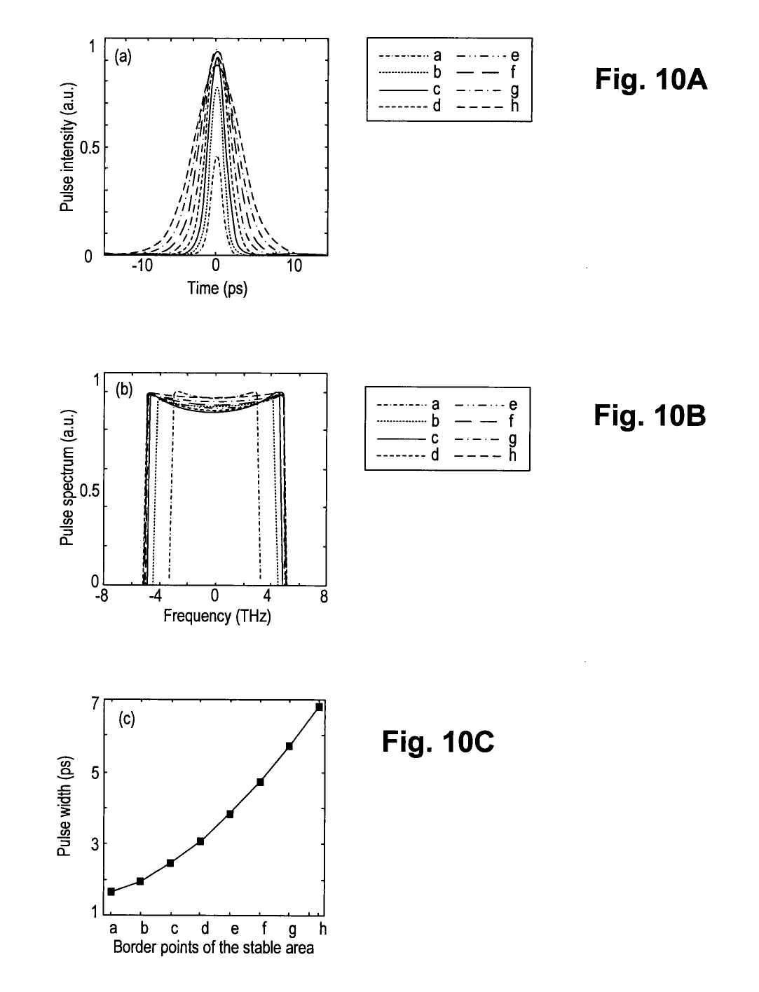

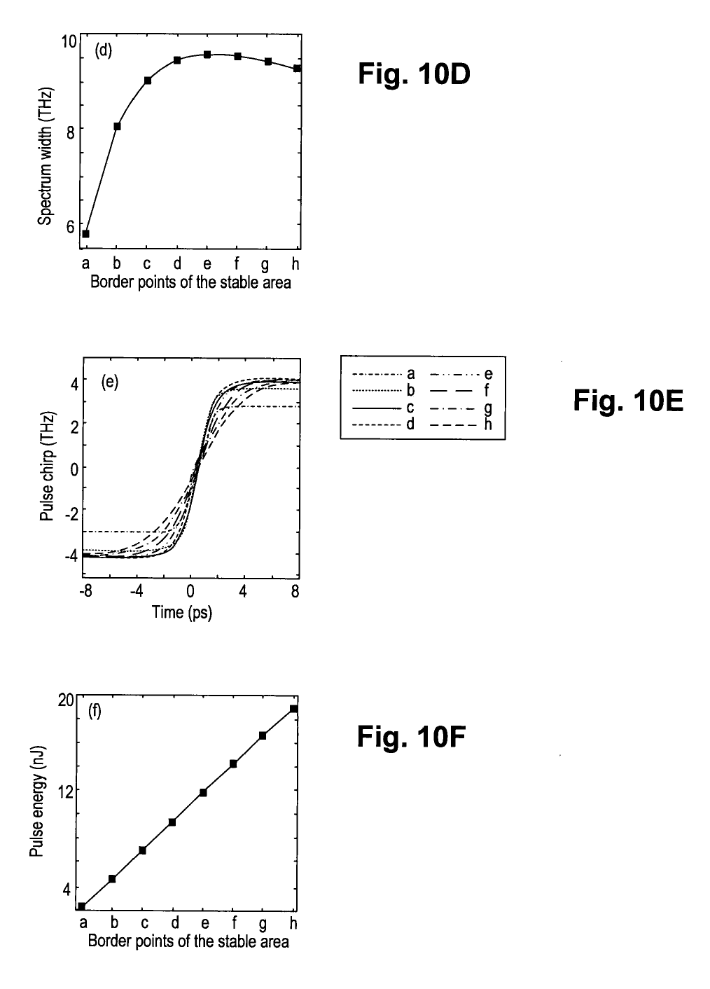

Next, the instabilities which occur with the mode-locked dissipative soliton pulses developed initially from noise are studied. First, the instability threshold as a function of the Yb length and bandwidth is studied. The calculations are limited in this part up to 1 m of the Yb-fiber length. This is because it is experimentally difficult to achieve uniform amplification inside the Yb fiber for longer lengths and the pulse may encounter some absorption. Referring to FIG. 9, there is a wide area for the stable mode-locked operation denoted by “5”. The lower stability boundary is approximately linear as shown by the dotted line in FIG. 9. This means that as the length of the Yb-doped fiber increases, the minimum value of the bandwidth required to get a stable pulse increases in approximately linear fashion. At short Yb-fiber lengths below 0.25 m for our particular cavity parameters, the gain is not sufficient to compensate for the cavity loss so this area is called “lossy” area, denoted by “L”. The area denoted by “U” is the unstable area within which the initial mode-locking happens but the generated pulse is converted into chaos with time i.e. after many roundtrips. Snapshots of the instability dynamics in the U-area are discussed below. The pulse characteristics; temporal, spectrum, and chirp at different points denoted by a, b, c, d, e, f, g, and h on the edge of the stability area from FIG. 9 are plotted in FIGS. 10A-10F. It can be seen that the temporal shapes of the dissipative soliton pulses are of hyperbolic-secant profile with different widths. The spectrum profiles of the dissipative solitons on the edge of the stability region plotted in FIG. 10B, remain approximately M-like shaped for by Yb-doped fiber length. The temporal pulse width increases monotonically from the lower value points to the higher value points as shown in FIG. 100. While the spectrum width increases first with the cavity length and get its maximum value approximately at point e after which the spectrum decreases as it is seen in FIG. 10D. The pulse chirp also demonstrates extreme (this time, minimum) near point e as shown in FIG. 10E. As expected the pulse energy increases along the instability boundary as shown in FIG. 10F.

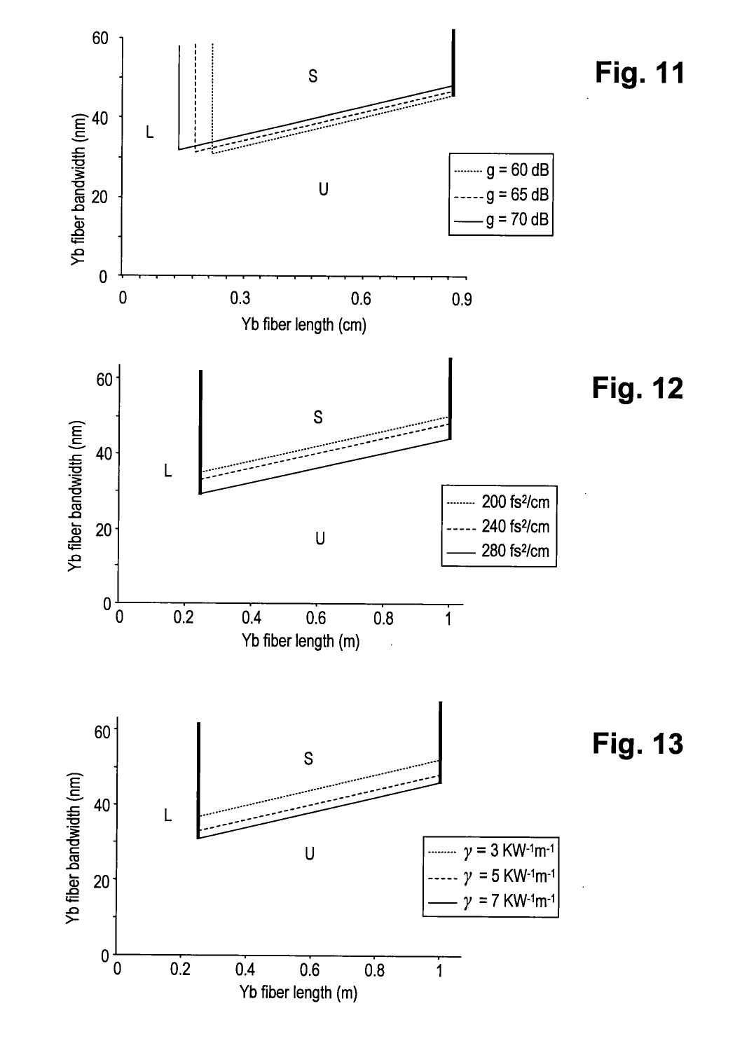

The stability area “S” shown in FIG. 9 is affected by changing the Yb-fiber gain. FIG. 11 demonstrates the displacement of the stability border as the Yb fiber gain changes. The stability area moves to the left-upper direction of the domain with increasing the Yb-fiber gain. This means that as the pumping increases, the minimum Yb-fiber length required to get stable mode-locked operation decreases and vice versa. Noteworthy here is that in the initial investigation for wider range of gain it is found other nontrivial dynamics like formation of coupled solitons. The formation and the dynamics of multisoliton will be fully described below.

Referring to FIG. 12, as the GVD increases the stability domain in the Yb-doped fiber parameters space broadens in a unique way. Stable operation can be achieved at smaller Yb-fiber gain BW. It can be explained by the fact that GVD widens the temporal pulse profile and decreases spectrum width. In turn, the amplitude modulation resulted from the narrower Yb-fiber band width is required to destabilize the pulse. Since the GVD has approximately no effect on the pulse energy as explained above so it does not displace the vertical border of the lossy “L” area.

FIG. 13 shows how the Yb-fiber nonlinearity shifts the stability border. It is seen that stability domain shrinks with the increase of nonlinearity. In contrast to the GVD case, the pulse spectral width grows with nonlinearity so that destabilization of the pulse occurs at larger Yb-fiber bandwidth. Again, the weak dependence of the pulse energy on the nonlinearity does not move vertical border of the stability domain.

It should be noted that another parameter which affects stability is the nonlinear modulator (saturable absorber) which is modeled by intensity dependent transmission through the polarizer in our case. It is shown that in simulations that for weaker modulation, a wider Yb-fiber bandwidth is necessary to keep pulse stable.

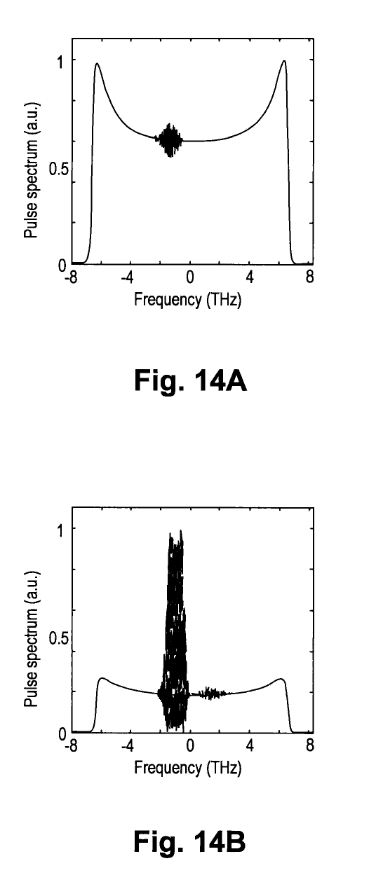

At any point in the area denoted by “U” in FIG. 11, a dissipative soliton that initially arises from laser noise collapses into chaos. It has been found that in this area, the pulse becomes unstable with time. An example of the instability dynamics of the initially formed dissipative soliton within “U” is illustrated in FIG. 14. After the pulse formation, the instability depicts itself through small ripples in the middle of the spectrum. These weak ripples become stronger with time until the pulse disappears and the chaos appears. The instability dynamics of the dissipative soliton with a narrower Yb-doped fiber bandwidth is similar to that found previously for the similariton regime.

Numerical simulations demonstrate that a stable mode-locked pulse operation can be achieved in the relatively simple Yb-doped fiber laser cavity comprised of Yb-fiber with positive GVD and a saturable absorber. This structure is able to deliver pulses with higher peak power and avoid the optical wave breaking at the same time. The Yb-doped fiber parameters such as GVD, nonlinearity, bandwidth, length, and gain are considered as controlling elements of this cavity. Simulation reveals many stable pulses with different spectral profiles exist.

A transition from an M-like shape to a Π-like shape and then to a parabolic-like shape of the pulse spectrum is observed. This is similar to what has been reported before in a solid state laser. The impact of different cavity elements on the temporal and spectral characteristics of the pulse is presented. It has been found that GVD widens the pulse width and decreases the spectrum width while the nonlinearity does the opposite. Moreover, the amplitude modulation role of the Yb-fiber gain bandwidth is demonstrated. Lengthening the Yb-fiber widens both the temporal and the spectrum widths of the generated pulse due to the increase of both the group velocity dispersion and the gain of the cavity. Increasing Yb-fiber gain narrows the pulse and widens the spectrum due to nonlinearity effect. The domain within which a stable mode-locked pulse can be generated as a function of the laser parameters is identified. The characteristics of the pulse on the edge of a stable area are discussed. The shift of the stability border in response to changing the Yb-fiber parameters such as gain, GVD is elucidated. Finally, the instability dynamics of the pulse outside the stable regions is studied and it seems to be similar to that reported before for similariton.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A mode-locked fiber laser system, comprising:
a laser source operable to produce a light beam;
an optical cavity structure optically coupled to the laser source and operable to amplify a light beam propagating therethrough, the optical cavity includes a gain fiber section doped with a lanthanide element, where a ratio between length of the gain fiber section to a total length of the cavity structure is greater than 1:5; and
an output coupler disposed in the optical cavity structure and operable to output the amplified light beam.

2. The fiber laser system of claim 1 wherein the optical cavity structure further includes a single-mode fiber section, where the ratio between length of the gain fiber section to length of the single-mode fiber section is greater than 1:3.

3. The fiber laser system of claim 1 wherein the optical cavity structure further includes a single-mode fiber section, where the length of the gain fiber section exceeds the length of the single-mode fiber section.

4. The fiber laser system of claim 1 wherein the gain fiber section is doped at a concentration that is substantially less than 200×10²⁴ ions/m³.

5. The fiber laser system of claim 1 wherein the gain fiber section is doped at a concentration on the order of 30×10²⁴ ions/m³.

6. The fiber laser system of claim 1 wherein the gain fiber section is doped with at least one of erbium or ytterbium.

7. The fiber laser system of claim 1 wherein the optical cavity structure is void of any optical components that perform spectral filtering or dispersion compensation.

8. The fiber laser system of claim 1 further comprises an input coupler that optically couples the laser source to the gain fiber section of the optical cavity structure.

9. The fiber laser system of claim 8 further comprises a single-mode fiber section interposed between the output coupler and the input coupler.

10. A mode-locked fiber laser system, comprising:
a laser source operable to produce a light beam;
a gain fiber optically coupled at an input to the laser source, the gain fiber doped ytterbium;
a mode locking mechanism having an input optically coupled to an output of the gain fiber and operable to output pulses of light; and
another fiber having an input optically coupled to the output of the mode locking mechanism, where a ratio between length of the gain fiber to length of the another fiber is greater than 1:3.

11. The fiber laser system of claim 10 wherein the length of the gain fiber exceeds the length of the another fiber.

12. The fiber laser system of claim 10 wherein the gain fiber, the another fiber and the mode locking mechanism for a optical cavity structure, where the ratio between length of the gain fiber section to a total length of the cavity structure is greater than 1:5.

13. The fiber laser system of claim 10 wherein the gain fiber section is doped at a concentration that is substantially less than 200×10²⁴ ions/m³.

14. The fiber laser system of claim 10 wherein the gain fiber section is doped at a concentration on the order of 30×10²⁴ ions/m³.

15. The fiber laser system of claim 10 further comprises a wavelength division multiplexer coupler configured to receive the light beam from the laser source and light output from the single-mode fiber and output light to the input of the gain fiber.

16. The fiber laser system of claim 15 wherein the mode locking mechanism employs nonlinear polarization evolution to generate pulses of light.

17. The fiber laser system of claim 15 wherein the mode locking mechanism employs a semi-conductor saturable absorber to generate pulses of light.

18. The fiber laser system of claim 15 further comprises an isolator, a polarization beam splitter and a wave plate.

19. The fiber laser system of claim 18 wherein the optical cavity structure is void of any optical components that perform spectral filtering or dispersion compensation.

20. A method for constructing a femtosecond fiber laser, comprising:
optically coupling a laser source to an input of a gain fiber doped with a lanthanide element;
optically coupling an input of a mode locking mechanism to an output of the gain fiber;
optically coupling a single-mode fiber to an output of the mode locking mechanism, thereby forming an optical cavity; and
increasing length of the gain fiber section in relation to length of the single-mode fiber while maintaining length of the optical cavity constant.

21. The method of claim 18 further comprises adjusting gain bandwidth of the gain fiber to provide spectral filtering of light passing therethrough.
